(19) United States
(12) Patent Application Publication
(10) Pub. No.: US 2022/0318339 A1
(43) Pub. Date: Oct. 6, 2022

(54) GRAPH INFORMATION CALCULATION APPARATUS, GRAPH INFORMATION CALCULATION METHOD, AND NON-TRANSITORY COMPUTER-READABLE MEDIUM

(71) Applicant: NEC Corporation, Tokyo (JP)

(72) Inventor: Takashi MARUYAMA, Tokyo (JP)

(73) Assignee: NEC Corporation, Tokyo (JP)

(21) Appl. No.: 17/708,400

(22) Filed: Mar. 30, 2022

(30) Foreign Application Priority Data
Apr. 5, 2021 (JP) 2021-063869

(51) Int. Cl. G06F 17/16; G06F 5/00

(52) U.S. Cl. CPC G06F 17/16; G06F 5/00

(57) ABSTRACT

A graph information calculation apparatus according to the present disclosure includes: a memory storing instructions; and at least one processor configured to execute the instructions to: receive a graph as an input, calculate a neighborhood structure of a vertex constituting the graph, and calculate a first set having a vertex constituting the calculated neighborhood structure as an element; calculate a path having a vertex constituting the graph as an end point, and calculate a second set having a vertex constituting the calculated path as an element; and convert the first set and the second set into a vector.

### INCORPORATION BY REFERENCE

This application is based upon and claims the benefit of priority from Japanese patent application No. 2021-063869, filed on Apr. 5, 2021, the disclosure of which is incorporated herein in its entirety by reference.

### TECHNICAL FIELD

The present disclosure relates to a graph information calculation apparatus, a graph information calculation method, and a non-transitory computer-readable medium.

### BACKGROUND ART

Information of molecular compounds, information and communication technology (ICT) systems, social networks, or the like may be represented in a graph. In addition, when a task such as regression or classification on such information represented by a graph is performed, feature value extraction processing of extracting a feature value represented by a vector or the like from the graph may be performed as preprocessing. In the feature value extraction processing, it is required that a feature value different from a feature value extracted from a graph having a certain structure is extracted from a graph having a different structure from the graph having the certain structure. Therefore, accuracy of the feature value extraction processing affects success or failure of a subsequent task such as regression or classification.

In the following description, it is assumed that a graph represents a graph in which a vector is provided in each vertex and each side, and a vector provided in a vertex and a side is referred to as an attribute vector. Each component of the attribute vector is a real number value.

One typical technique being used for the feature value extraction processing on a graph is a graph neural network (GNN) model. One processing unit of the GNN model is constituted of two processes. One process is a process to be performed on each vertex in the graph, referred to as vertex aggregation processing. Hereinafter, a vertex on which the vertex aggregation processing is performed is referred to as a base point. In the vertex aggregation processing, vertexes connected to a base point via sides are collected at each base point, and computation is performed on a set of attribute vectors of the collected vertexes. This computation is achieved, for example, by an operation of calculating an average or a sum of the attribute vectors, a maximum value or a minimum value of each component of the attribute vectors, or the like. The other process is a process referred to as conversion processing, in which the attribute vector acquired in the previous vertex aggregation processing is converted once into a vector that may have a different dimension, and the converted vector is replaced as an attribute vector of the vertexes on the graph.

The GNN model updates the attribute vector of each vertex on an input graph by repeating the vertex aggregation processing and the conversion processing with respect to the input graph as one processing unit, converts the updated attribute vectors of all the vertexes into a single vector, and outputs the vector acquired by the conversion as a feature value of the input graph.

The GNN model is proposed, for example, in NPL 1 (T. N. Kipf and M. Welling, “Semi-supervised classification with graph convolutional networks”, At ICLR 2017), and in NPL 2 (Peter W. Battaglia et al., “Relational inductive biases, deep learning, and graph networks”, arXiv: 1806.01261v3, 17 Oct. 2018).

NPL 1 proposes a method of classifying vertexes of a graph or the graph itself by using the GNN model in semi-supervised learning. In addition, NPL 1 proposes a method of using an adjacency matrix of a graph as a method of the vertex aggregation processing of the GNN model.

In NPL 2, various forms of GNN models are systematically organized. A graph network (GN) block in NPL 2 represents one processing unit of the above-described GNN model, and conversion processing therein is achieved by a linear conversion or a multi-layer perceptron model.

The GNN model proposed in NPLs 1 and 2 updates the attribute vector of the vertex constituting the graph by repeating the vertex aggregation processing and the conversion processing a prescribed number of times. At this time, when the number of repetition times is N, vertexes collected in the vertex aggregation processing on each vertex of the graph are all vertexes located in a region of N hops or less from a base point being a target of the vertex aggregation processing.

However, in the GNN model proposed in NPLs 1 and 2, when the vertex aggregation processing and the conversion processing are performed on each of a plurality of graphs and an attribute vector of a vertex is updated, sets of attribute vectors of all vertexes constituting the graphs may coincide with each other between the graphs, and the feature values output from the GNN model may coincide with each other. This is due to a fact that sets of vertexes located in regions of N hops or less being collected in the vertex aggregation processing coincide between the graphs.

FIG. 1 is a diagram for explaining a problem of the present disclosure. FIG. 1 illustrates two graphs having different topologies, in which sets of vertexes collected in the vertex aggregation processing coincide between the graphs when N=1. In FIG. 1, each diagram surrounded by rounded rectangles 11 and 12 illustrated by broken lines each represents one graph. A circle, a triangle, a square, and a hexagon in each of the graphs 11 and 12 all represent vertexes of the graphs, and a line segment between the vertexes represent a side. Characters x, y, z, and w assigned to each of the vertexes represent attribute vectors, and different characters represent different attribute vectors.

Herein, it is assumed that targets of the vertex aggregation processing in the graphs 11 and 12 are vertexes 111 and 121, respectively. At this time, vertexes collected in the vertex aggregation processing on the vertex 111 are vertexes 112, 113, and 114, and attribute vectors of the vertexes 112, 113, and 114 are w, z, and w, respectively. Meanwhile, vertexes collected in the vertex aggregation processing on the vertex 121 are vertexes 122, 123, and 124, and attribute vectors of the vertexes 122, 123, and 124 are w, z, and w, respectively. Therefore, although the two graphs illustrated in FIG. 1 have different topologies, sets of attribute vectors of vertexes collected in the vertex aggregation processing on each of the vertexes 111 and 121 coincide with each other.

Herein, while one vertex is selected from each of the graphs 11 and 12, and it is confirmed that the sets of the attribute vectors collected in a process of the vertex aggregation processing on each of the selected vertexes coincide with each other, the same can be said for other vertexes. In other words, there is such an one-to-one mapping between vertex sets of each of the graphs 11 and 12 that sets of attribute vectors collected in the vertex aggregation processing on vertexes that reflects to each other in the one-to-one mapping coincide with each other.

Therefore, when the graphs 11 and 12 exemplified in FIG. 1 are given as inputs of the GNN model, there is a problem that the GNN model outputs the same feature values.

Note that, while FIG. 1 exemplifies that the feature values extracted from each of the two graphs coincide when N=1, feature values extracted from each of the two graphs may differ when N=2. Therefore, it is considered that the above-described problem can be solved by increasing the number of repetition times of the vertex aggregation processing and the conversion processing.

However, the number of repetition times is a fixed value when the GNN model is learned or inferred. Therefore, the number of repetition times required for acquiring a feature value being output from the GNN model may differ depending on a graph, and in that case, there may occur a problem that sets of attribute vectors provided in the vertexes used in the vertex aggregation processing coincide with each other as described above. Therefore, a method of increasing the number of repetition times is not suitable as a solution to the above-described problem.

### SUMMARY

Therefore, a one of object of the present disclosure is to solve the above-mentioned problem and to provide a graph information calculation apparatus, a graph information calculation method, and a non-transitory computer-readable medium that are capable of extracting more subdivided feature values from different graphs.

A graph information calculation apparatus according to one aspect includes:

a memory storing instructions; and

at least one processor configured to execute the instructions to:

receive a graph as an input,

calculate a neighborhood structure of a vertex constituting the graph, and calculate a first set having a vertex constituting the calculated neighborhood structure as an element;

calculate a path having a vertex constituting the graph as an end point, and calculate a second set having a vertex constituting the calculated path as an element; and

convert the first set and the second set into a vector.

A graph information calculation method according to one aspect is a graph information calculation method performed by a graph information calculation apparatus, and the method includes:

a step of receiving a graph as an input;

a step of calculating a neighborhood structure of a vertex constituting the graph and calculating a first set having a vertex constituting the calculated neighborhood structure as an element;

a step of calculating a path having a vertex constituting the graph as an end point and calculating a second set having a vertex constituting the calculated path as an element, and

a step of converting the first set and the second set into a vector.

A non-transitory computer-readable medium according to one aspect is a non-transitory computer-readable medium storing a graph information calculation program for causing a computer to execute:

a procedure of receiving a graph as an input;

a procedure of calculating a neighborhood structure of a vertex constituting the graph and calculating a first set having a vertex constituting the calculated neighborhood structure as an element;

a procedure of calculating a path having a vertex constituting the graph as an end point and calculating a second set having a vertex constituting the calculated path as an element; and

a procedure of converting the first set and the second set into a vector.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram for explaining the problem of the present disclosure.

FIG. 2 is a block diagram illustrating a configuration example of a graph information calculation apparatus according to an example embodiment.

FIG. 3 is a diagram schematically illustrating an example of processing by a neighborhood information calculation unit according to the example embodiment.

FIG. 4 is a diagram schematically illustrating an example of processing by a path information calculation unit according to the example embodiment.

FIG. 5 is a diagram schematically illustrating an example of processing by a vector computation unit according to the example embodiment.

FIG. 6 is a flowchart for explaining an example of a process of processing by the graph information calculation apparatus according to the example embodiment.

FIG. 7 is a diagram for explaining an advantageous effect of the example embodiment.

FIG. 8 is a block diagram illustrating an example of a hardware configuration of a computer that achieves the graph information calculation apparatus according to the example embodiment.

### EXAMPLE EMBODIMENTS

In the following, an example embodiment of the present disclosure will be described with reference to the drawings. Note that the following description and the drawings are appropriately omitted and simplified for clarity of description. In the following drawings, the same elements are denoted by the same reference signs, and a repetitive description thereof is omitted as necessary.

### Configuration of Example Embodiment

First, a configuration of a graph information calculation apparatus according to the present example embodiment will be described.

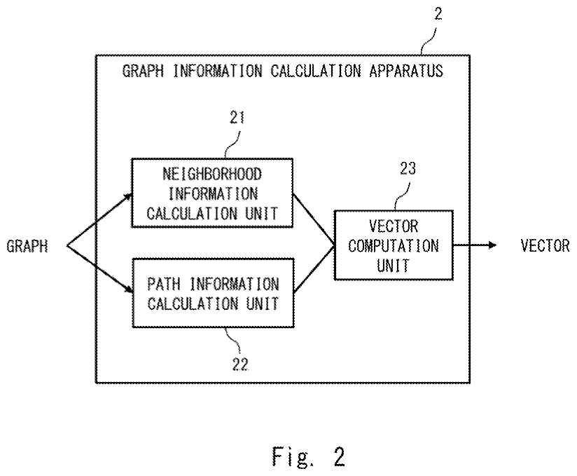

FIG. 2 is a block diagram illustrating a configuration example of a graph information calculating apparatus 2 according to the present example embodiment. As illustrated in FIG. 2, the graph information calculation apparatus 2 according to the present example embodiment includes a neighborhood information calculation unit 21, a path information calculation unit 22, and a vector computation unit 23.

The neighborhood information calculation unit 21 receives a graph as an input, calculates a neighborhood structure of a vertex constituting the input graph, and calculates a vertex set that is a set (first set) having vertexes constituting the neighborhood structure as elements. The neighborhood structure calculated by the neighborhood information calculation unit 21 is a subset of a vertex set and a side set constituting the graph, and a vertex and a side belonging to the subset are determined according to whether a specific condition is satisfied.

The path information calculation unit 22 receives the graph as an input, calculates a path having a vertex constituting the input graph as an end point, and calculates a set (second set) having vertexes constituting the path as elements. The set calculated by the path information calculation unit 22 may be a set further having a side constituting the path as an element. Herein, the “vertex” constituting the graph may be referred to as a “node” and the “line segment (side)” may be referred to as an “edge” (hereinafter, the same applies in the present application).

The vector computation unit 23 receives the vertex set calculated by the neighborhood information calculation unit 21 and the set calculated by the path information calculation unit 22 as inputs, converts the input two sets into a vector, and outputs the converted vector.

### Operation of Example Embodiment

Hereinafter, operations of the neighborhood information calculation unit 21, the path information calculation unit 22, and the vector computation unit 23 will be described in more detail.

The neighborhood information calculation unit 21 receives a graph as an input, calculates a neighborhood structure of each vertex constituting the input graph, and calculates a vertex set having vertexes constituting the neighborhood structure as elements.

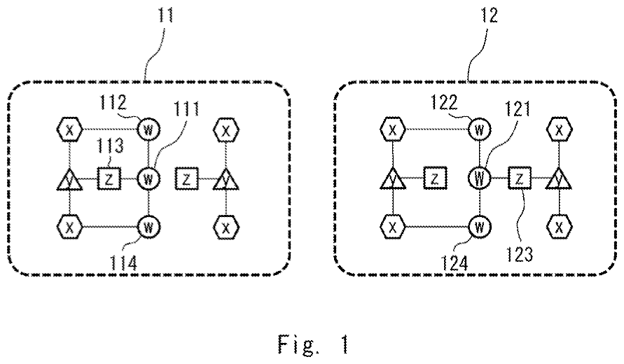

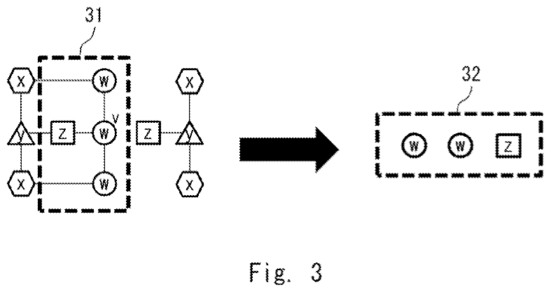

FIG. 3 is a diagram schematically illustrating an example of processing by the neighborhood information calculation unit 21. In FIG. 3, an input graph is the graph 11 in FIG. 1, and the processing target of the neighborhood information calculation unit 21 is vertex v. A rectangle 31 illustrated by a broken line represents a neighborhood structure of the vertex v, and a rectangle 32 illustrated by a broken line represents a vertex set having vertexes constituting the neighborhood structure 31 as elements.

As illustrated in FIG. 3, the neighborhood information calculation unit 21 receives the graph 11 in FIG. 1 as an input, and calculates the neighborhood structure 31 constituted of vertexes adjacent to the vertex v via sides. After that, the neighborhood information calculation unit 21 calculates a vertex set 32 having, as elements, the vertexes that constitute the neighborhood structure 31 and are adjacent to the vertex v via the sides.

The neighborhood structure 31 may be a partial structure of a graph uniquely determined for each vertex, and may be, for example, a partial structure constituted of vertexes located in a region of N hops or less from a vertex. Alternatively, in the neighborhood structure 31, a partial structure may be predetermined for each type of vertex of the graph as a neighborhood structure. The vertex set 32 may include a base point (the vertex v in the example of FIG. 1) on which the processing by the neighborhood information calculation unit 21 is performed.

The path information calculation unit 22 receives a graph as an input, and calculates, for each vertex constituting the input graph, a path having the vertex as an end point and path information of the path. Herein, it is assumed that a path represents a row of vertexes in a graph, and vertexes adjacent to each other in the row represents vertexes adjacent to each other via a side in the graph. Further, it is assumed that path information represents a set having vertexes constituting a path as elements.

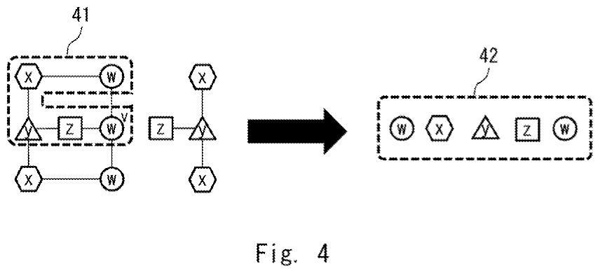

FIG. 4 is a diagram schematically illustrating an example of processing by the path information calculation unit 22. In FIG. 4, an input graph is the graph 11 in FIG. 1, and a processing target of the path information calculation unit 22 is the vertex v.

As illustrated in FIG. 4, the path information calculation unit 22 calculates a path 41 having the vertex v as an end point. After that, the path information calculation unit 22 calculates, from the calculated path 41, path information representing a set 42 having vertexes constituting the path 41 as elements.

The path information calculation unit 22 may calculate a plurality of paths for one vertex, and may calculate path information representing a set having vertexes of the plurality of paths as elements. Further, the path may be a row satisfying the definition of a path, and a type of the path is not limited. The path may be a shortest path or a path calculated by random walk.

In addition, the set 42 may be a set further having a side constituting the path 41 as an element, or may be the path information itself.

The vector computation unit 23 receives, as an input, for each vertex constituting the graph, the vertex set of the vertex calculated by the neighborhood information calculation unit 21 and the set of the vertex calculated by the path information calculation unit 22, and converts the two sets into a vector by performing computation on the vectors provided in the elements of the two sets.

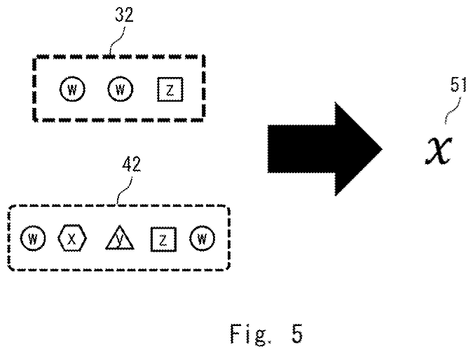

FIG. 5 is a diagram schematically illustrating an example of processing by the vector computation unit 23. In FIG. 5, a processing target of the vector computation unit 23 is the vertex v (see FIGS. 3 and 4). The broken line rectangle 32 represents the vertex set calculated by the neighborhood information calculation unit 21 for the vertex v, and the rectangle 42 illustrated by a dashed line represents the set calculated by the path information calculation unit 22 for the vertex v.

As illustrated in FIG. 5, the vector computation unit 23 performs computation on vectors provided in the elements constituting the vertex sets 32 and 42. Through this computation, the vector computation unit 23 converts the vertex sets 32 and 42 into a vector 51, and outputs the converted vector 51.

This computation may be computation of converting a set of vectors into a vector. The conversion may be, for example, linear conversion, conversion using a multi-perceptron model, or the like.

The vector computation unit 23 may divide the vertex set 32 and the set 42 into subsets, perform different computation for each of the subsets, and output results of the computation. For example, the vector computation unit 23 may perform computation of multiplying the number of the elements of the set 42 or an inverse number thereof by a vector of each vertex of the vertex set 32, and after that, may perform the conversion.

The neighborhood information calculation unit 21, the path information calculation unit 22, and the vector computation unit 23 are achieved by, for example, a central processing unit (CPU) of a computer that operates in accordance with a graph information calculation program. In this case, the CPU may read the graph information calculation program from a program recording medium such as a program storage device of the computer, and may operate as the neighborhood information calculation unit 21, the path information calculation unit 22, and the vector computation unit 23, in accordance with the graph information calculation program.

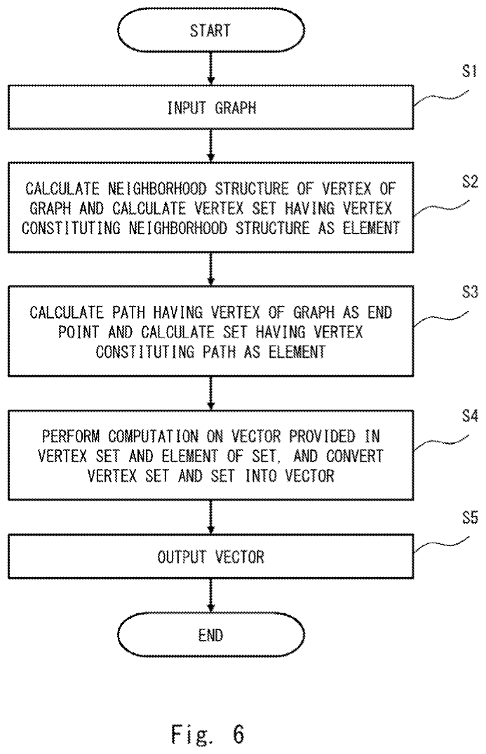

Next, a process of the processing by the graph information calculation apparatus 2 according to the present example embodiment will be described. FIG. 6 is a flowchart for explaining an example of the process of the processing by the graph information calculation apparatus 2 according to the present example embodiment. In the following description, description of an item already described is omitted as appropriate.

As illustrated in FIG. 6, first, a graph is input to the neighborhood information calculation unit 21 and the path information calculation unit 22 (Step S1).

Next, the neighborhood information calculation unit 21 calculates a neighborhood structure of a vertex constituting the graph input in Step S1, and calculates a vertex set having vertexes constituting the neighborhood structure as elements (Step S2).

Next, the path information calculation unit 22 calculates a path having a vertex constituting the graph input in Step S1 as an end point, and calculates a set having vertexes constituting the path as elements (Step S3).

Next, the vector computation unit 23 receives the vertex set calculated in Step S2 and the set calculated in Step S3 as inputs. Further, the vector computation unit 23 converts the two sets into a vector by performing computation on the vectors provided in the elements of the two sets (Step S4). Thereafter, the vector computation unit 23 outputs the vector acquired by the conversion in Step S4 (Step S5).

### Advantageous Effects of Example Embodiment

As described above, according to the graph information calculation apparatus 2 according to the present example embodiment, the path information calculation unit 22 is provided and thereby it is possible to increase input information to the vector computation unit 23. This makes it possible to extract a more subdivided feature value from the input graph.

Hereinafter, an advantageous effect of the present example embodiment will be described in more detail.

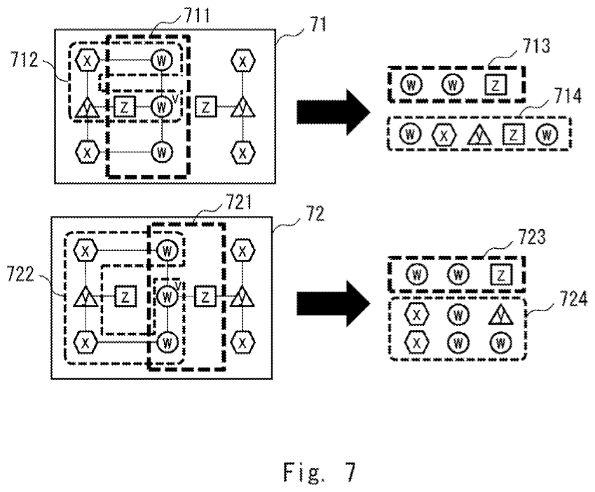

FIG. 7 is a diagram for explaining the advantageous effect of the present example embodiment. FIG. 7 illustrates that the sets calculated by the neighborhood information calculation unit 21 and the path information calculation unit 22 are different in the two graphs.

In FIG. 7, diagrams surrounded by solid-line rectangles 71 and 72 each represents one graph. Further, the graphs 71 and 72 are the same as the graphs 11 and 12 in FIG. 1, respectively.

In the graph 71, 711 represents a neighborhood structure calculated by the neighborhood information calculation unit 21, and 713 represents a vertex set calculated from the neighborhood structure 711. Meanwhile, in the graph 72, 721 represents a neighborhood structure calculated by the neighborhood information calculation unit 21, and 723 represents a vertex set calculated from the neighborhood structure 721. Herein, the vertex set 713 for the graph 71 coincides with the vertex set 723 for the graph 72 as a set.

In the graph 71, reference numeral 712 denotes a path calculated by the path information calculation unit 22, and reference numeral 714 denotes a set of vertexes constituting the path 712. On the other hand, in the graph 72, 722 represents a path calculated by the path information calculation unit 22, and 724 represents a set of vertexes constituting the path 722. Here, the set 714 for the graph 71 and the set 724 for the graph 72 are different as sets.

A merged set acquired by merging the vertex set 713 and the set 714 is a vertex set calculated by the neighborhood information calculation unit 21 and the path information calculation unit 22 from the input graph 71. The merged set acquired by merging the vertex set 723 and the set 724 is a vertex set calculated by the neighborhood information calculation unit 21 and the path information calculation unit 22 from the input graph 72. Herein, the merged set for the graph 71 and the merged set for the graph 72 are different as sets.

As described above, according to the graph information calculation apparatus 2 according to the present example embodiment, since the path information calculation unit 22 is provided, it is possible to distinguish between vertexes that cannot be distinguished only by the neighborhood information calculation unit 21. Therefore, input information to the vector computation unit 23 is increased in such a way that the vertexes can be distinguished from each other, and as a result, a difference can be created in the feature value to be extracted from the graph. This makes it possible to extract a more subdivided feature value from the input graph.

<Hardware Configuration of Graph Information Calculation Apparatus According to Example Embodiment>

Next, a configuration of a computer for achieving the graph information calculation apparatus 2 according to the present example embodiment will be described.

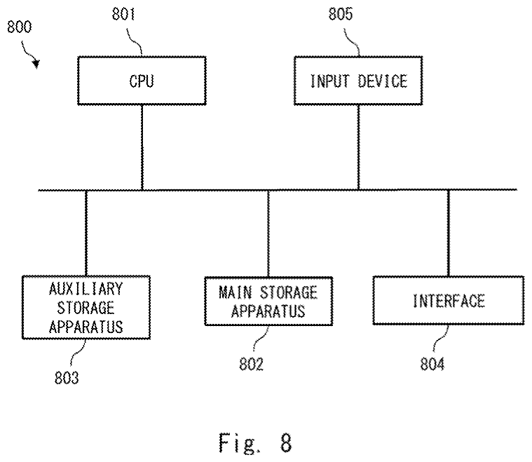

FIG. 8 is a block diagram illustrating an example of a hardware configuration of a computer 800 for achieving the graph information calculation apparatus 2 according to the present example embodiment. As illustrated in FIG. 8, the computer 800 includes a CPU 801, a main storage apparatus 802, an auxiliary storage apparatus 803, an interface 804, and an input device 805.

The graph information calculation apparatus 2 according to the present example embodiment is implemented in the computer 800. An operation of the graph information calculation device 2 is stored in the auxiliary storage apparatus 803 in a form of a graph information calculation program. The CPU 801 reads out the graph information calculation program from the auxiliary storage apparatus 803, extracts the graph information calculation program in the main storage apparatus 802, and executes the processing described in the above example embodiment, in accordance with the graph information calculation program.

The auxiliary storage apparatus 803 is an example of a non-transitory physical medium. Other examples of non-transitory physical media include a magnetic disk, a magneto-optical disk, a compact disk read only memory (CD-ROM), a digital versatile disk read only memory (DVD-ROM), a semiconductor memory, and the like, connected via the interface 804. When the graph information calculation program is distributed to the computer 800 through a communication line, the computer 800 that has received the distribution may extract the graph information calculation program in the main storage device 802 and execute the above processing.

Some or all of the constituent elements of the graph information calculation apparatus 2 according to the present example embodiment may be achieved by a general-purpose or single-purpose circuitry, a processor, or a combination thereof. The circuitry and the like may be configured by a single chip, or may be configured by a plurality of chips connected via a bus. In addition, some or all of the constituent elements may be achieved by a combination of the above-described circuitry and the like and a program.

When some or all of the constituent elements of the graph information calculating apparatus 2 according to the present example embodiment are achieved by a plurality of information processing apparatuses, circuitries, and the like, the plurality of information processing apparatuses, circuitries, and the like may be centrally arranged or distributed. For example, the information processing apparatuses, the circuitries, and the like may be achieved as a form of a client-server system, a cloud computing system, and the like, in which each of the information processing apparatus, the circuitries, and the like is connected via a communication network.

Further, the above-described program may be stored in a non-transitory computer-readable medium or a physical storage medium. As an example and not as a limitation, the computer-readable medium or the physical storage media includes a random-access memory (RAM), a read-only memory (ROM), a flash memory, a solid-state drive (SSD) or another memory technology, a CD-ROM, a digital versatile disk (DVD), a Blu-ray (registered trademark) disk or another optical disk storage, aa magnetic cassette, a magnetic tape, a magnetic disk storage, or another magnetic storage devices. The program may be transmitted over a temporary computer-readable medium or a communication medium. As an example and not as a limitation, the temporary computer-readable medium or the communication medium includes electrical, optical, acoustic, or other forms of a propagated signal.

While industrial applicability of the present disclosure is obvious from the above description, the present disclosure is applicable, for example, to the following cases.
A case of extracting a feature value from a graph representing a molecular compound in a drug discovery industry
A case of extracting a feature value from a graph representing a social network or a graph representing an internet technology (IT)/communication network (NW) system

Although the present disclosure has been described above with reference to the example embodiment, the present disclosure is not limited to the example embodiment described above. Various modifications may be made to the structure and details of the present disclosure as will be understood by those skilled in the art within the scope of the present disclosure.

What is claimed is:

1. A graph information calculation apparatus comprising:
a memory storing instructions; and
at least one processor configured to execute the instructions to:
receive a graph as an input,
calculate a neighborhood structure of a vertex constituting the graph, and calculate a first set having a vertex constituting the calculated neighborhood structure as an element;
calculate a path having a vertex constituting the graph as an end point, and calculate a second set having a vertex constituting the calculated path as an element; and
convert the first set and the second set into a vector.

2. The graph information calculation apparatus according to claim 1, wherein the at least one processor is configured to execute the instructions to convert the first set and the second set into a vector by performing computation on vectors provided in an element of the first set and an element of the second set.

3. The graph information calculation apparatus according to claim 2, wherein the at least one processor is configured to execute the instructions to convert the first set and the second set into a vector by performing computation of multiplying the number of elements of the second set by a vector provided in a vertex being an element of the first set.

4. The graph information calculation apparatus according to claim 2, wherein the at least one processor is configured to execute the instructions to convert the first set and the second set into a vector by performing computation of multiplying an inverse number of the number of elements of the second set by a vector provided in a vertex being an element of the first set.

5. The graph information calculation apparatus according to claim 1, wherein the at least one processor is configured to execute the instructions to calculate the second set further having a side constituting the calculated path as an element.

6. A graph information calculation method performed by a graph information calculation apparatus, the method comprising:
a step of receiving a graph as an input;
a step of calculating a neighborhood structure of a vertex constituting the graph, and calculating a first set having a vertex constituting the calculated neighborhood structure as an element;
a step of calculating a path having a vertex constituting the graph as an end point, and calculating a second set having a vertex constituting the calculated path as an element; and
a step of converting the first set and the second set into a vector.

7. A non-transitory computer-readable medium storing a graph information calculation program for causing a computer to execute:
a procedure of receiving a graph as an input;
a procedure of calculating a neighborhood structure of a vertex constituting the graph and calculating a first set having a vertex constituting the calculated neighborhood structure as an element;
a procedure of calculating a path having a vertex constituting the graph as an end point, and calculating a second set having a vertex constituting the calculated path as an element; and
a procedure of converting the first set and the second set into a vector.
